(19) United States
(12) Patent Application Publication
(10) Pub. No.: US 2012/0045696 A1
(43) Pub. Date: Feb. 23, 2012

(54) NEGATIVE ELECTRODE MATERIALS FOR NON-AQUEOUS ELECTROLYTE SECONDARY BATTERY

(76) Inventor: P. Subramanya Herle, Mountain View, CA (US)

(21) Appl. No.: 12/861,296

(22) Filed: Aug. 23, 2010

(51) Int. Cl. H01M 10/0562; B05D 5/12; H01M 10/30; H01M 4/134; H01M 4/139

(52) U.S. Cl. 429/322; 429/219; 429/220; 429/222; 429/223; 429/224; 429/229; 429/231.5; 429/231.95; 427/126.1

(57) ABSTRACT

A negative electrode of a non-aqueous electrolyte secondary battery comprises a current collector and a mixture comprising a negative electrode active material, a conductive material, and a binder on the current collector. The negative electrode active material has the overall composition: MₐSi_{b}P_{c}B_{d}; in which: 0<a<1, 0<b<1, 0<c<1, 0<d<1, and a+b+c+d=1; and M is selected from the group consisting of Ti, Zr, Hf, V, Nb, Ta, Cr, Mo, W, Tc, Cu, Zn, Pd, Ag, Cd, Au, Mn, Co, Ni, Sn, and Re, and mixtures thereof. A non-aqueous electrolyte secondary battery comprises a positive electrode, the negative electrode, and a non-aqueous electrolyte between the positive and negative electrodes. A method for preparing the negative electrode comprises the steps of preparing a mixture comprising a negative electrode active material, a conductive material, a binder, and a solvent; coating the mixture on a current collector; and drying the mixture.

### FIELD OF THE INVENTION

This invention relates to a negative electrode for a non-aqueous secondary battery and to a method of producing the negative electrode. More particularly, the invention relates to a negative electrode that comprises a negative electrode active material that is capable of reversibly absorbing an alkali metal, such as lithium.

### BACKGROUND OF THE INVENTION

Cordless portable electronic devices, such as personal computers, cell phones, and personal digital assistants (PDA), as well as audio-visual electronic devices, such as video camcorders and mini-disc players, are rapidly becoming smaller and lighter in weight. Because these devises are designed to be light-weight and compact, a demand for compact and light-weight secondary batteries that have a higher energy density than that obtainable by conventional lead-acid batteries, nickel-cadmium storage batteries, or nickel-metal hydride storage batteries has developed.

Non-aqueous electrolyte secondary batteries have been extensively developed to meet this demand. Although lithium is the best candidate for the anode material (3860 mAh/g), repeated dissolution and deposition of lithium during discharging and charging cycles causes the formation of dendritic lithium on the surface of the lithium. Dendrites decrease charge-discharge efficiency and can pierce through the separator and contact the positive electrode, causing a short circuit and unacceptably shortening the life of the battery.

To overcome this problem, carbon materials, such as graphite, capable of absorbing and desorbing lithium have been used as the negative electrode active material in lithium non-aqueous electrolyte secondary batteries. When a graphite material is used as the negative electrode active material, lithium is released at an average potential of about 0.2 V. Because this potential is low compared to non-graphite carbon, graphite carbon has been used in applications where high voltage and voltage flatness are desired. However, the search for alternate anode materials is continuing because the theoretical discharge capacity of graphite is only about 372 mAh/g. Thus, these batteries cannot meet the demand for high energy density required for many light-weight mobile electrical and electronic devices.

Materials that are capable of absorbing and desorbing lithium and showing high capacity include simple heavy elements from groups 13 to 15 of the periodic table, such as silicon and tin. Elemental silicon and tin are high energy density materials, and they react with lithium at low voltage with respect to Li/Li⁺. However, absorption of lithium by silicon or by tin causes the silicon or tin to expand. When the battery case has low strength, such as a prismatic case made of aluminum or iron, or an exterior component which is made of an aluminum foil having a resin film on each face thereof (i.e., an aluminum laminate sheet), the battery thickness increases due to expansion of the negative electrode, such that an instrument comprising the battery could be damaged. In a cylindrical battery using a battery case with high strength, because the separator between a positive electrode and a negative electrode is strongly compressed due to volume expansion of the negative electrode, an electrolyte-depleting region is created between the positive electrode and the negative electrode, thereby making the battery life even shorter.

To address these problems, silicon, tin, and silicon/tin composites, with or without carbon, have been proposed as alternative anode materials for lithium secondary batteries. For example, Miyaki, U.S. Pat. Publication 2005/0181276, relates to Co—Sn amorphous composites with carbon for nonaqueous electrolyte secondary batteries. Kawakami, U.S. Pat. Publication 2005/0175901, describes anode materials containing Sn-transition metals and alkali/alkaline earth/p-block element-alloys for non-aqueous secondary batteries. Yamamoto, U.S. Pat. Publication 2005/0084758, relates to carbon coated with Si/Sn anodes for lithium batteries.

However, these materials still have the disadvantage of volume expansion upon incorporation of lithium. They develop cracks and eventually fall off the current collector as the charge/discharge cycle is repeated. Because all the silicon-silicon or the tin-tin bonds are broken when an alloy with maximum lithium content is formed, it is desirable to have an anode material having a larger free volume for lithium ions within the host structure. It is also desirable to use an inexpensive compound that is also non-polluting, to make the battery environmentally benign.

### SUMMARY OF THE INVENTION

In one aspect, the invention is a negative electrode for non-aqueous electrolyte secondary batteries. The negative electrode comprises a high energy density anode material that prolongs electrode life and is inexpensive and environmentally benign. The negative electrode comprises:

a negative electrode current collector, and, on the negative electrode current collector, a mixture comprising a negative electrode active material, a conductive material, and a binder;

the negative electrode active material has the overall composition:

MₐSi_{b}P_{c}B_{d};

in which:

0<a<1, 0<b<1, 0<c<1, 0<d<1, and a+b+c+d=1;

and

M is selected from the group consisting of Ti, Zr, Hf, V, Nb, Ta, Cr, Mo, W, Tc, Cu, Zn, Pd, Ag, Cd, Au, Mn, Co, Ni, Sn, and Re, and mixtures thereof.

In another aspect, the invention is a non-aqueous electrolyte secondary battery comprising a positive electrode, a negative electrode, and a non-aqueous electrolyte between the positive electrode and the negative electrode. The non-aqueous electrolyte comprises a non-aqueous solvent and a lithium salt. The positive electrode comprises a positive electrode current collector, and, on the positive electrode current collector, a mixture comprising a positive electrode active material capable of occluding and releasing lithium ions, a first conductive material, and a first binder. The negative electrode comprises a negative electrode current collector, and, on the negative electrode current collector, a mixture comprising a negative electrode active material as described above, a second conductive material, and a second binder.

In yet another aspect, the invention is a method for preparing the negative electrode of a non-aqueous electrolyte secondary battery. The method comprises preparing a mixture comprising a negative electrode active material, a conductive material, a binder, and a solvent; coating the mixture on a current collector; and drying the mixture to produce the negative electrode, wherein the negative electrode active material has the overall composition described above.

### BRIEF DESCRIPTION OF THE DRAWINGS

FIG. 1 is a schematic drawing of a non-aqueous electrolyte secondary battery.

FIG. 2 shows the X-ray (Cu-Kα) powder diffraction (30 kV, 40 mA) pattern for a Mo—Si—P—B composition in accordance with of the present invention.

FIG. 3 shows the charge-discharge curves for a Mo—Si—P—B composition in accordance with the present invention.

FIG. 4 shows the differential scanning calorimeter curves for a Mo—Si—P—B composition in accordance with the present invention.

### DETAILED DESCRIPTION OF THE INVENTION

Unless the context indicates otherwise, in the specification and claims, the terms metal, binder, conductive material, negative electrode active material, positive electrode active material, lithium salt, non-aqueous solvent, additive, and similar terms also include mixtures of such materials. Unless otherwise specified, all percentages are percentages by weight and all temperatures are in degrees Centigrade (degrees Celsius).

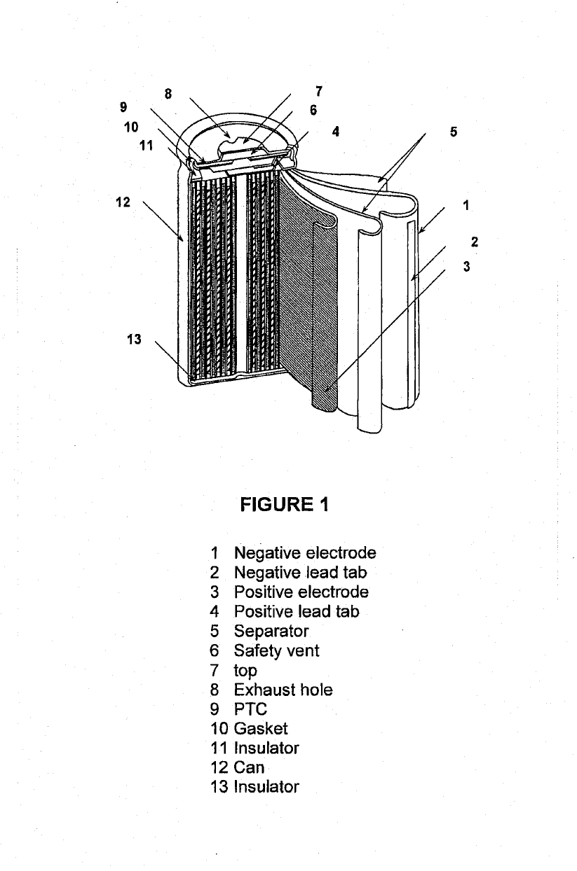

Referring to FIG. 1, a non-aqueous secondary battery comprises negative electrode 1, negative lead tab 2, positive electrode 3, positive lead tab 4, separator 5, safety vent 6, top 7, exhaust hole 8, PTC (positive temperature coefficient) device 9, gasket 10, insulator 11, battery case or can 12, and insulator 13. Although the non-aqueous secondary battery is illustrated as a cylindrical structure, any other shape, such as prismatic, aluminum pouch, or coin type may be used. Negative electrode 1, positive electrode 3, and separator 5 are contained within battery case 12. A non-aqueous electrolyte is between the positive electrode 3 and the negative electrode 1.

Negative electrode 1 comprises a current collector and, on the current collector, a mixture comprising a negative electrode active material, a conductive material, and a binder.

The current collector can be any conductive material that does not chemically change within the range of charge and discharge electric potentials used. Typically, the current collector is a metal such as copper, nickel, iron, titanium, or cobalt; an alloy comprising at least one of these metals such as stainless steel; or copper or stainless steel surface-coated with carbon, nickel, or titanium. The current collector may be, for example, a film, a sheet, a mesh sheet, a punched sheet, a lath form, a porous form, a foamed form, a fibrous form, or, preferably, a foil. A foil of copper or a copper alloy, or a foil having a copper layer deposited on its surface by, for example electrolytic deposition, is preferred. The current collector is typically about 1-500 μm thick. It may also be roughened to a surface roughness of Rₐ of 0.2 μm or more to improve adhesion of the mixture of the negative electrode active material, the conductive material, and the binder to the current collector. For example, an 11 μm (0.011 mm) thick copper current collector was utilized for the tests detailed in the Examples below.

According to an embodiment of the present invention, the negative electrode active material has the overall composition:

MₐSi_{b}P_{c}B_{d};

in which:

0<a<1, 0<b<1, 0<c<1, 0<d<1, and a+b+c+d=1;

and

M is selected from the group consisting of Ti, Zr, Hf, V, Nb, Ta, Cr, Mo, W, Tc, Cu, Zn, Pd, Ag, Cd, Au, Mn, Co, Ni, Sn, and Re, and mixtures thereof.

The electrode active material is a quaternary composition that includes, phosphorus, silicon, boron, and a metal selected from the group consisting of Ti, Zr, Hf, V, Nb, Ta, Cr, Mo, W, Tc, Cu, Zn, Pd, Ag, Cd, Au, Mn, Co, Ni, Sn, and Re, and mixtures thereof, or their amorphous or at least partially crystalline layered composites. Examples of mixtures of metals that may be used as M include, for example, MoₓSi₁₋ₓ where 0<x<1; TiₓSi₁₋ₓ where 0<x<1; ZrₓSi₁₋ₓ where 0<x<1; and NbₓSi₁₋ₓ where 0<x<1. Composites forming the overall composition of the active material may be at least partially crystalline layered, as in fully crystalline layered-layered composites or partially crystalline layered-nonlayered composites. The active material composition may alternatively be formed by entirely amorphous structures, such as in nonlayered-nonlayered composites. Furthermore, the active material composition may initially be at least partially crystalline but become amorphous upon reversible absorption of an alkali metal, such as lithium. The transition from an amorphous overall composition to an at least partially crystalline structure is also possible over repeated absorption-desorption cycles, as is well known in the art.

In at least one embodiment of the invention: 0<a≦0.20. A preferred composition is, for example, M-Si—P₂—B. (i.e., M_{0.20}Si_{0.20}P_{0.40}B_{0.20}). Although the oxygen content of the electrode active materials is desirably zero, some oxygen may be introduced during preparation of the electrode active material. However, any oxygen that is present in the electrode active material is not considered in calculation of the formula MₐSi_{b}P_{c}B_{d}.

The negative electrode active material may be a single material that has the indicated composition. Alternatively, it may be a mixture of materials (e.g., containing two transition metals) that has the indicated overall composition.

When molybdenum (Mo) is selected as element M, the negative electrode active material has the formula:

MoₐSi_{b}P_{c}B_{d};

in which:

0<a<1, 0<b<1, 0<c<1, 0<d<1, and a+b+c+d=1.

That is, the negative electrode active material is a quaternary composition of molybdenum, silicon, phosphorus, and boron (Mo—Si—P—B), or their amorphous or at least partially-layered composites. Suitable overall compositions include, but are not limited to, Mo—Si—P₂—B. The composite can be amorphous, crystalline, or a mixture of both amorphous and crystalline materials. The oxygen content of the negative electrode active materials is desirably zero.

The negative electrode active material of the present invention advantageously has a low (base) electrode potential which is expected to be less than, or equal to, 1V. The boron, or boride (as the boron may exist in a chemical compound as a composite with one of the other elements), has a lower oxidation-reduction potential compared to the phosphorus or phosphides. This is believed to be because boron is less electronegative than phosphorus. The lower oxidation-reduction potential allows for a higher voltage battery when combined with a high voltage positive electrode material. Additionally, because the materials may have at least a partially-layered crystal structure, these materials have better charge and discharge characteristics. This crystal structure may change in the first cycle of lithium desorption and may also result in the formation of an amorphous reactive lithium absorbing phase or phases for subsequent cycles. This leads to better overall battery performance, such as longer cycle life and superior charge and discharge characteristics.

The presence of an early transition metal from the group consisting of Ti, Zr, Hf, V, Nb, Ta, Cr, Mo, W, Tc, Cu, Zn, Pd, Ag, Cd, Au, Mn, Co, Ni, Sn, and Re, and mixtures thereof, contributes to the electrical conductivity of the negative electrode active material. Without being limited to any theory, it is believed that the unique nature of the frontier d electrons of these transition metals contributes to their useful characteristics such as conductivity, mixed valency, and non-stoichiometry. For example, it is now identified that the addition of Li into the spinel structure of Li₄Ti₅O₁₂ can create a Li₇Ti₅O₁₂ composition with no volume change.

The silicon component also contributes to these characteristics of the negative electrode active material of the present invention, as silicon is a high lithium-absorbing material. Prior negative electrode active materials have included a binary phosphide for this purpose. However, as silicon has been found to have a higher lithium-absorbing capacity than binary metal phosphides, it is advantageous to employ silicon in the present invention. Without being held to the theory, it is believed that the characteristics of silicon, coupled with the characteristics of the other components of the present invention, effectively function to increase lithium capacity of the anode and minimize volume expansion upon incorporation of lithium.

At least part of the surface of the negative electrode active material is covered with a conductive material. Any conductive material known in the art can be used. Typical conductive materials include carbon, such as graphite, for example, natural graphite (scale-like graphite), synthetic graphite, and expanding graphite; carbon black, such as acetylene black, KETZEN® black (highly structured furnace black), channel black, furnace black, lamp black, and thermal black; conductive fibers such as carbon fibers and metallic fibers; metal powders such as copper and nickel; organic conductive materials such as polyphenylene derivatives; and mixtures thereof. Synthetic graphite, acetylene black, and carbon fibers are preferred.

The binder for the negative electrode can be either a thermoplastic resin or a thermosetting resin. Suitable binders may be, for example, organic solvent-based or water-based binders. Useful binders include: polyethylene, polypropylene, polytetrafluoroethylene (PTFE), polyvinylidene fluoride (PVDF), styrene/butadiene rubber, tetrafluoroethylene/hexafluoropropylene copolymers (FEP), tetrafluoroethylene/perfluoro-alkyl-vinyl ether copolymers (PFA), vinylidene fluoride/-hexafluoropropylene copolymers, vinylidene fluoride/chlorotrifluoroethylene copolymers, ethylene/tetrafluoroethylene copolymers (ETFE), polychlorotrifluoroethylene (PCTFE), vinylidene fluoride/pentafluoropropylene copolymers, propylene/tetrafluoroethylene copolymers, ethylene/-chlorotrifluoroethylene copolymers (ECTFE), vinylidene fluoride/-hexafluoropropylene/tetrafluoroethylene copolymers, vinylidene fluoride/-perfluoromethyl vinyl ether/tetrafluoroethylene copolymers, and mixtures thereof. Water-based binders such as CMC, butyl rubber and their mixtures are also appropriate binders. Polytetrafluoroethylene, polyvinylidene fluoride, and water-based binders are preferred binders.

The negative electrode may be prepared by mixing the negative electrode active material, the binder, and the conductive material with a solvent, such as N-methylpyrrolidone (NMP). The resulting paste or slurry is coated onto the current collector by any conventional coating method, such bar coating, gravure coating, die coating, roller coating, or doctor knife coating. Typically, the current collector is dried to remove the solvent and then rolled under pressure after coating. The mixture of negative electrode active material, binder, and conductive material typically comprises the negative electrode active material, at least enough conductive material for good conductivity, and at least enough binder to hold the mixture together. The negative electrode active material may typically comprise from about 1 wt % to about 99 wt % of the mixture of negative electrode active material, binder, and conductive material. In a preferred embodiment, the active material comprises about 80 wt % to about 99 wt % of the composition.

In one procedure for the preparation of the negative electrode active materials, the starting materials, that is silicon (Si), phosphorus (P), boron (B), and the metal or metals (M), are mixed together in a predetermined molar ratio. Known sources of these starting materials may be used, but preferably the elements themselves are used. The starting materials may be mixed, for example, as dry powders, or dispersed in a solvent for wet grinding and then dried.

The mixture of starting materials can be heated directly or can be pressed into a pellet before heating. The mixture can be jacketed in evacuated sealed silica ampoules or sealed into a metal container first and then jacketed into evacuated silica ampoules. The heating rate and cooling rate can be controlled, for example, by furnace, or the heated materials can be quenched from high-temperatures using, for example, liquid nitrogen. The duration of heating and subsequent heat cycles can also be controlled to achieve the desired material. Heating after or while these materials are mixed differs depending on the starting materials or the thermal treatment atmosphere. The negative electrode active materials may be synthesized at a temperature equal to or less than 1000° C. at the first heating, more preferably at a temperature equal to or more than 600° C. on first heating. Regrinding after the first heating, followed by a second heating in suitable atmosphere can vary from 700° C. to 1500° C. more preferably below 1300° C. To promote the synthesis reaction and to increase the uniformity of the product, the processes of heating, cooling/quenching, grinding/mixing and reheating can be repeated.

Another method of producing negative electrode active materials of the formula MₐSi_{b}P_{c}B_{d}, in which a is not equal to zero, is to first prepare a phosphide, Si_{b}P_{c}, and then react the phosphide with the metal or metals (M) and boron. One method to synthesize phosphides of the formula Si_{b}P_{c} is from elemental silicon and elemental phosphorus by thermal treatment as described above. When using pure silicon, or silicon with a low level of silicon oxide, as the source of silicon and using elemental phosphorus as the source of phosphorus, the phosphide can be synthesized by thermal-treatment of the mixture of these materials in a non-oxidizing atmosphere. After silicon and phosphorus are mixed at a predetermined mole ratio or while being mixed, the mixture is heated in a non-oxidizing atmosphere, such as an inert atmosphere or a vacuum, or in an atmosphere where the amount of oxygen is controlled, such as an evacuated sealed tube sealed in a silica container.

Another method is to first prepare a compound of metal or metals (M) and phosphorus, and then react it with a silicon boride to obtain the desired overall composition of the negative electrode active materials. For example, a typical composite that is at least partially layered is SiB+MoP₂ (for an overall composition of Mo—Si—P₃). The overall composition Mo—Si—P₂—B (i.e., Mo_{0.2}—Si_{0.2}—P_{0.4}—B_{0.2}) can be obtained by preparing the boride SiB and reacting it with a compound of MoP₂. The boride SiB and the compound MoP₂ are known to be a crystalline structures. Reacting these structures causes a readily cleavable van der Waals force or interaction within the composite, as is well known in the art. Thus the typical active material may include both composites and homogenous compounds, such as homogenous compounds of Mo—Si—P₂—B. Other overall compositions of the active materials can be achieved through van der Waals interactions within amorphous composites or other at least partially layered composites.

Other methods for preparing the negative electrode active materials may be used. For example, another method is to atomize or ionize these materials by heating or with electromagnetic radiation, such as with light, and simultaneously, or alternatively, to vaporize and deposit the same by, for example, laser pyrolysis. Reaction in the gas phase can sometimes produce fine particles at low synthesis temperature compared to the high temperature required by solid state synthesis. Synthesis at high pressure may also be applicable to the preparation of the negative electrode active materials. Furthermore, specific morphology designs, such as fibrous nano-dimensioned materials, may be achieved by suitably modifying the synthesis process conditions.

Incorporation of lithium into the negative electrode active materials can be accomplished by electrochemical reaction within a battery after assembling the battery. Alternatively, incorporation may be carried out inside or outside the battery depending on the production process of the battery. In one method, the negative electrode active material is mixed with a conductive agent and a binding agent, and formed into a predetermined shape to obtain an electrode (working electrode). Lithium metal or a material containing lithium metal is used as the other electrode (counter electrode). The electrodes are arranged opposing each other in contact with non-aqueous electrolyte that conducts lithium ions to form an electrochemical cell with a suitable porous separator facing the electrodes, and a suitable current in a direction to conduct lithium ions to the working electrode is passed through the cell so that lithium is electrochemically incorporated into the negative electrode active material. The resulting working electrode is used as a negative electrode for a lithium non-aqueous secondary battery.

In another method, lithium metal, lithium alloy, or a material containing lithium metal is press fit or contact bonded to the working electrode to produce a laminated electrode. The laminated electrode is assembled into a lithium non-aqueous electrolyte secondary battery. By contacting the laminated electrode with the electrolyte within the battery, a local cell is formed and the lithium is thus electrochemically incorporated into the negative electrode active material. In yet another method, an electrode comprising the negative electrode active material is used as the negative electrode and a material containing lithium and capable of incorporating and releasing lithium ions is used as a positive active material in a positive electrode. Lithium ions released from the positive electrode by charging are incorporated into the negative electrode active material. Lithium can also be introduced into negative electrode active material by chemical methods by using organo-lithium compounds in a suitable solvent media at an appropriate temperature.

Positive electrode 3 typically comprises a current collector and, on the current collector, a mixture comprising a positive electrode active material, a conductive material, and a binder. Typical current collectors, conductive materials, and binders for the positive electrode include the current collectors, conductive materials, and binders described above for the negative electrode.

The positive electrode active material may be any compound containing lithium that is capable of occluding and of releasing lithium ions (Li⁺). A transition metal oxide, with an average discharge potential in the range of 3.5 to 4.5 V with respect to lithium, has typically been used. As the transition metal oxide, lithium cobalt oxide (LiCoO₂), lithium nickel oxide (LiNiO₂), lithium manganese oxide (LiMn₂O₄), a solid solution material (LiCOₓNi_{y}Mn_{z}O₂; Li(COₐNi_{b}Mn_{c})₂O₄); or LiMPO₄, Li₂MPO₄F, LixM₂(PO₄)₃ (where M is selected from the group consisting of Ti, Zr, Hf, V, Nb, Ta, Cr, Mo, W, Tc, Cu, Zn, Pd, Ag, Cd, Au, Mn, Co, Ni, Sn, and Re, and mixtures thereof) with a plurality of transition metals introduced thereto, and the like, have been used. The average diameter of particles of the positive electrode active material is preferably about 1-30 μm.

The positive electrode can be prepared by mixing the positive electrode active material, the binder, and the conductive material with a solvent and coating the resulting slurry on the current collector as was described for preparation of the negative electrode.

In the non-aqueous electrolyte secondary battery, preferably at least the surface of the negative electrode having the mixture comprising the negative electrode material is facing the surface of the positive electrode having the mixture comprising the positive electrode material with a porous separator.

The non-aqueous electrolyte is typically capable of withstanding a positive electrode that discharges at a high potential of 3.5V to 4.5V and also capable of withstanding a negative electrode that charges and discharges at a potential close to that of lithium. The non-aqueous electrolyte comprises a non-aqueous solvent, or mixture of non-aqueous solvent, with a lithium salt, or a mixture of lithium salts, dissolved therein.

Typical non-aqueous solvents include, for example, cyclic carbonates as ethylene carbonate (EC), propylene carbonate (PC), dipropylene carbonate (DPC), butylene carbonate (BC), vinylene carbonate (VC), phenyl ethylene carbonate (ph-EC), and vinyl ethylene carbonate (VEC); open chain carbonates as dimethyl carbonate (DMC), diethyl carbonate (DEC), ethylmethyl carbonate (EMC); amides, such as formamide, acetamide, and N,N-dimethyl formamide; aliphatic carboxylic acid esters such as methyl formate, ethyl formate, methyl acetate, ethyl acetate, methyl propionate and ethyl propionate; diethers, such as 1,2-dimethoxyethane (DME), 1,2-diethoxyethane (DEE), and ethoxymethoxyethane (EME); cyclic ethers such as tetrahydrofuran, 2-methyl tetrahydrofuran, and dioxane; other aprotic organic solvents, such as acetonitrile, dimethyl sulfoxide, 1,3-propanesultone (PS) and nitromethane; and mixtures thereof. Typical lithium salts include, for example, lithium chloride (LiCl), lithium bromide (LiBr), lithium trifluoromethyl acetate (LiCF₃CO₂), lithium hexafluorophosphate (LiPF₆), lithium perchlorate (LiClO₄), lithium tetrafluoroborate (LiBF₄), lithium trifluoro-methansulfonate (LiCF₃SO₃), lithium hexafluoroarsenate (LiAsF₆), bis(trifluoromethyl)sulfonylimido lithium [LiN(CF₃SO₂)₂], lithium bisoxalato borate (LiB(C₂O₄)₂), and mixtures thereof.

Preferably, the non-aqueous electrolyte is one obtained by dissolving lithium hexafluoro phosphate (LiPF₆) in a mixed solvent of ethylene carbonate (EC), which has a high dielectric constant, and a linear carbonate or mixture of linear carbonates that are low-viscosity solvents, such as, for example, diethyl carbonate (DEC), dimethyl carbonate (DMC), and ethyl methyl carbonate (EMC). The concentration of lithium ion in the non-aqueous electrolyte is typically about 0.2 mol/l to about 2 mol/l, preferably about 0.5 mol/l to about 1.5 mol/l.

Other compounds may be added to the non-aqueous electrolyte in order to improve discharge and charge/discharge properties. Such compounds include triethyl phosphate, triethanolamine, cyclic ethers, ethylene diamine, pyridine, triamide hexaphosphate, nitrobenzene derivatives, crown ethers, quaternary ammonium salts, and ethylene glycol di-alkyl ethers.

Separator 5, between the positive electrode and the negative electrode, is insoluble and stable in the electrolyte solution. It prevents short circuits by insulating the positive electrode from the negative electrode. Insulating thin films with fine pores, which have a large ion permeability and a predetermined mechanical strength, are used. Polyolefins, such as polypropylene and polyethylene, and fluorinated polymers such as polytetrafluoroethylene and polyhexafluoropropylene, can be used individually or in combination. Sheets, non-wovens, and wovens made with glass fiber can also be used. The diameter of the fine pores of the separators is typically small enough so that positive electrode materials, negative electrode materials, binders, and conductive materials that separate from the electrodes can not pass through the separator. A desirable diameter is, for example, 0.01-1 μm. The thickness of the separator is generally 10-300 μm. The porosity is determined by the permeability of electrons and ions, material, and membrane pressure; in general, however, it is desirably 30-80%.

For polymer secondary batteries, gel electrolytes comprising these non-aqueous electrolytes retained in the polymer as plasticizers, have also been used. Alternatively, the electrolyte may be polymer solid electrolyte or gel polymer electrolyte, which comprises a polymer solid electrolyte mixed with organic solvent provided as a plasticizer. Effective organic solid electrolytes include polymer materials such as derivatives, mixtures and complexes of polyethylene oxide, polypropylene oxide, polyphosphazene, polyaziridine, polyethylene sulfide, polyvinyl alcohol, polyvinylidene fluoride, polyhexafluoropropylene. Among inorganic solid electrolytes, lithium nitrides, lithium halides, and lithium oxides are well known. Among them, Li₄SiO₄, Li₄SiO₄—LiI—LiOH, xLi₃PO₄-(1-x)Li₄SiO₄, Li₂SiS₃, Li₃PO₄—Li₂S—SiS₂, and phosphorus sulfide compounds are effective. When a gel electrolyte is used, a separator is typically not necessary.

The positive electrode, the negative electrode, and the electrolyte are contained in a battery case or can. The case may be made of example, titanium, aluminum, or stainless steel that is resistant to the electrolyte. As shown in FIG. 1, the non-aqueous secondary battery may also comprise lead tabs, safety vents, insulators, and other structures.

This invention provides a negative electrode for a non-aqueous secondary battery and a non-aqueous secondary battery of high reliability and safety. These non-aqueous secondary batteries are used in portable electronic devices such as personal computers, cell phones, and personal digital assistants, as well as audio-visual electronic devices, such as video camcorders and mini-disc players.

The advantageous properties of this invention can be observed by reference to the following examples, which illustrate but do not limit the invention.

### EXAMPLES

### Example 1

### Preparation of Negative Electrode Active Materials

Synthesis of the negative electrode active material involved grinding stoichiometric mixtures of M-Si—P—B, where M is a transition metal, in different proportions. Specifically, the negative electrode active materials, employing molybdenum (Mo) as the transition metal, were prepared by the following procedure. Elemental silicon, elemental phosphorus, elemental boron, and elemental molybdenum were mixed in a ZrO₂ planetary ball mill and ground using 50 grams of 2 mm zirconium oxide balls. The ZrO₂ jar was placed on a planetary mixer with acetone solvent for 2 hours at 500 rotations per minute. The grinding was stopped for 10 minute intervals every 30 minutes. After grinding was completed, the resulting powders were dried in air and ground further using an agate mortar. The resulting powders were then sieved through 200-size mesh.

These powders were then pressed into pellets (10 mm pellet diameter; 3 ton pressure) and sealed into evacuated SiO₂ ampoules with approximately 1×10⁻⁶ torr vacuum. The silica ampoules were heated at 950° C. for 24 hours with a heating rate of 5° C. per minute. Heating was carried out in a muffle furnace controlled by a programmable temperature controller. The sample was furnace cooled. After the first heat-treatment, the pellets were re-ground in an argon-filled glove box and pelletized, sealed, and reheated again using the same process. To promote the synthesis reaction, and to raise its uniformity, samples could be treated several times by the processes of heating, cooling/quenching, grinding/mixing and repeated heating cycles, as necessary for the solid state reaction. Ideal synthesis conditions for the solid state synthesis of M-Si—P—B compositions were identified by varying the temperature, duration of heating, and also cooling conditions. Table 1 lists the reaction conditions for the solid state reaction and the number of heat cycle repetitions for preparation of the negative electrode active material composition.

TABLE 1

| | | | Amount | | | | # of Heat |
|---|---|---|---|---|---|---|---|
| | | Amount | of Mo | Amount | Amount | | Cycle |
| Sample | Composition | of Si (g) | (g) | of P (g) | of B (g) | Heating | Repetitions |
| 1 | Mo—Si—P₂—B | 0.9594 | 0.6194 | 0.2808 | 0.1081 | 950° C., | 1 |
| | | | | | | 24 h | |

The resulting sample was then analyzed for X-ray diffraction patterns using a scanning electron microscope equipped with an energy dispersive X-ray spectroscopy analyzer (SEM-EDS). The X-ray diffraction analysis showed the presence of MoP. The analysis also showed that the sample had sub-micron sized particles with flakey morphology. Analysis of the sample also showed the presence of oxygen. As oxygen is desirably zero, the presence of oxygen was either due to exposure of the sample to air or some other introduction of oxygen during synthesis of the sample.

Table 2 shows the results of the X-ray diffraction analysis. All of the X-ray diffraction patterns had some unidentified phases. The detected phases for each sample and composition were searched and matched to the database of powder diffraction patterns known as the “JCPDS” managed by the International Centre for Diffraction Data. As stated above, the X-ray diffraction analysis showed the presence of MoP. However, the diffraction was very broad and no known phases in the JCPDS database matched exactly.

TABLE 2

| | | Primary | Primary | Other |
|---|---|---|---|---|
| | | Detected | Phase | Detected |
| Sample | Composition | Phase | JCPDS# | Phases |
| 1 | Mo—Si—P₂—B | MoP | 65-6487 | Additional Small |
| | | | | Intensity Peaks |

Table 3 shows the overall compositions for the samples, as identified by the X-ray diffraction analysis. As is known in the art, boron can not be detected using X-ray diffraction analysis and has been excluded.

TABLE 3

| | Composition in wt % (excluding boron) | | | |
|---|---|---|---|---|
| Sample | Mo | Si | P | O |
| 1 | 43.96 ± 0.52 | 14.46 ± 0.20 | 28.88 ± 0.35 | 13.10 ± 0.54 |

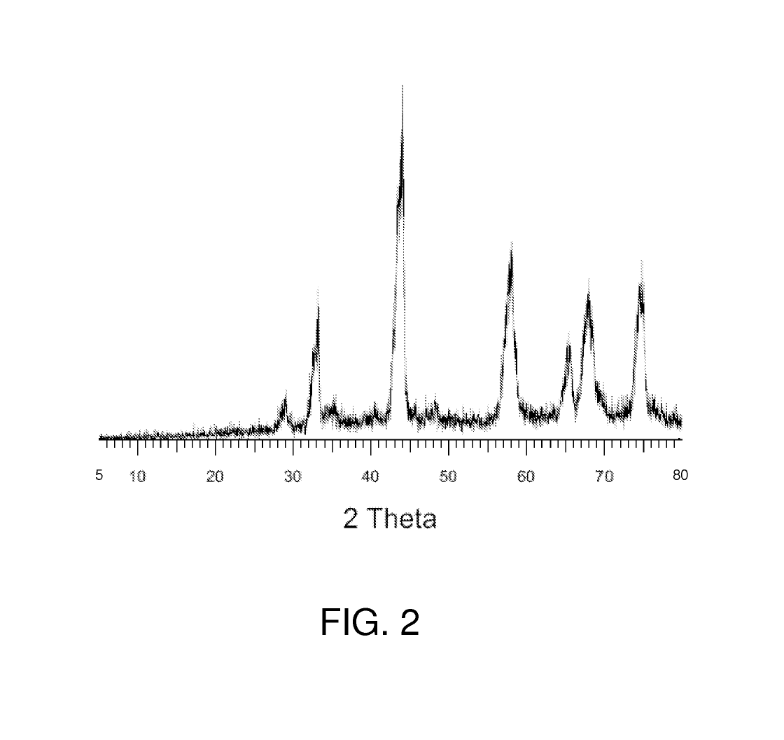

FIG. 2 shows the typical powder X-ray diffraction patterns for the negative electrode active materials of the present invention.

### Preparation of Batteries

The batteries were prepared by the following procedure. First, the negative electrode active material(s), acetylene black, VGCF carbon as a conductive material, polyvinyl difluoride (or polyvinylidene fluoride) (PVDF) binder, and N-methyl pyrollidone (NMP) solvent were mixed well. The weight ratio of negative electrode active material to the other components is shown in Table 4 below. The resulting mixture was coated on to a single side of copper foil using a doctor blade to achieve a 100 μm gage thick coating thickness, and dried at 60° C. for 2 hours. After drying, the negative electrode was cut into approximately 1 centimeter diameter circular tabs using a punch, and pressed to 3 ton pressure. The negative electrode was then heat treated at 320° C. for 2 hours in a tubular furnace with 1% hydrogen in argon (1% H₂—Ar) atmosphere, at a flow rate of 120 mL per minute.

For testing purposes, it was necessary to insert lithium into the negative electrode active material. Therefore, lithium metal was used as the opposite electrode. Because Li⁺/Li has a lower potential than the negative electrode active materials of the invention, under these conditions the lithium electrode becomes the negative electrode, and the negative electrode active material becomes the positive electrode. However, the negative electrode active materials of the invention are negative with respect to commonly used positive electrode active material, such as LiCoO₂.

The lithium electrode was fabricated by cutting lithium metal sheet of 200 micron thickness using a circular punch and adhered to a stainless steel or nickel disk (0.33 mm) spot welded with a stainless steel mesh. This circular lithium metal electrode with stainless steel or nickel current collector was used a negative electrode to insert and de-insert lithium from our test materials.

A Swagelok cell was constructed using the lithium metal as an anode and the Mo—Si—P₂—B composite as a cathode. A CELGARD® 2320 separator was utilized to separate the anode and cathode, and 1 M LiPF₆ in ethylene carbonate (EC):ethyl methyl carbonate (EMC) (1:3) formulations were used as an electrolyte. The electrodes were held together using a Swagelok assembly with stainless steel pistons using TEFLON® fluorocarbon resin ferrules, stainless steel spring and KAPTON® polyimide film surrounding the stainless steel piston, insulating the current collectors and separator from the main body.

### Example 2

A Swagelok cell was fabricated as described above using the compositions given in Table 4. A CELGARD® #2320 separator and electrolyte of 25 vol % of 1 M LiPF6 in ethylene carbonate and 75 vol % of ethyl methyl carbonate were used.

TABLE 4

| | Active | Acetylene | VGCF | Binder |
|---|---|---|---|---|
| Sample | Material | Black | Carbon | (PVDF) |
| Number | (%) | (%) | (%) | (%) |
| 1 | 32.91 | 29.97 | 3.99 | 33.1 |

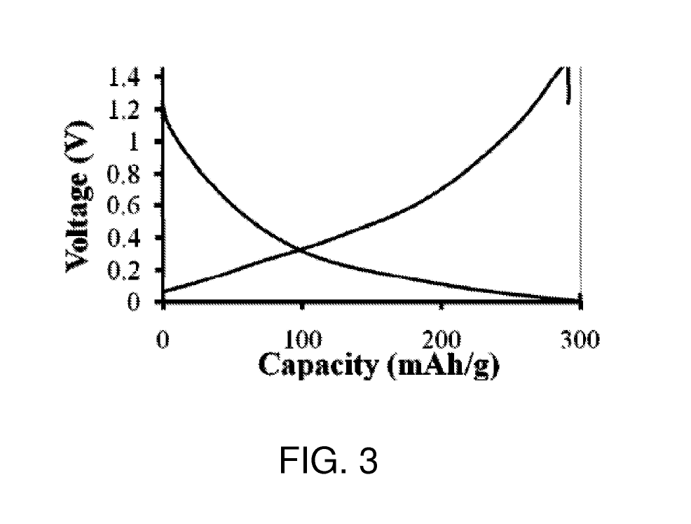

The electrochemical curve for the composition in Table 4, as tested within a Swagelok cell, is shown in FIG. 3. The electrochemical curve in FIG. 3 shows different plateaus upon lithium insertion and the discharge capacity was observed for the composition. The electrochemical conversion of one formula unit of MoₓSiP_{y}B to LiMoₓSiP_{y}B in one hour is understood to be a lithium insertion rate of 1 C. The electrode of the present example was cycled at a C/10 rate (i.e., rate of 0.1 C). The capacity of sample 1 showed good cycle performance while showing a decrease in capacity vs. cycle. These results can be seen in Table 5.

TABLE 5

| Sample | Cut Off | Cycle Number and Capacity (mAh/g) | | | | | |
|---|---|---|---|---|---|---|---|
| Number | Voltage (V) | 1 | 10 | 20 | 30 | 40 | 50 |
| 1 | 0 | 1283 | 423 | 381 | 345 | 315 | 296 |
| | 1.5 | 394 | 401 | 362 | 328 | 306 | 292 |

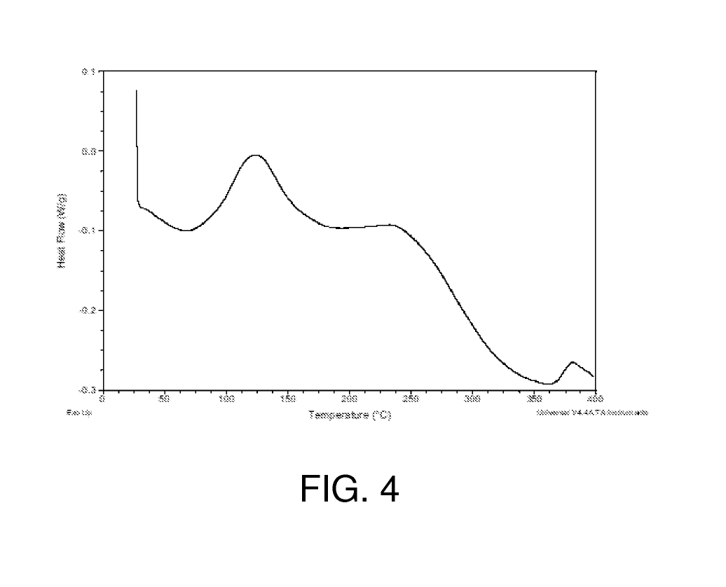

The sample was additionally analyzed using a differential scanning calorimeter (DSC), in which the difference in the amount of heat required to increase the temperature of a sample and reference is measured as a function of temperature. The main application of DSC is in studying phase transitions, such as melting, glass transitions, or exothermic decompositions. These transitions involve energy changes or heat capacity changes that can be detected by DSC with great sensitivity. Using this technique, it is possible to observe crystallization events. Transition from amorphous solid to crystalline solid is an exothermic process, and results in a peak in the DSC signal. The differential scanning calorimeter (DSC) analysis for the sample is shown in FIG. 4. The DSC measurements for the sample indicated one exothermic peak for the sample in the vicinity of 100° C. FIG. 4 shows good DSC measurements in terms of thermal characteristics as there are no large exothermic second peaks.

While preferred embodiments of the invention have been shown and described herein, it will be understood that such embodiments are provided by way of example only. Numerous variations, changes, and substitutions will occur to those skilled in the art without departing from the spirit of the invention. Accordingly, it is intended that the appended claims cover all such variations as fall within the spirit and scope of the invention.

What is claimed:

1. A negative electrode of a non-aqueous electrolyte secondary battery, the negative electrode comprising:
a current collector; and
a mixture comprising a negative electrode active material, a conductive material, and a binder on the current collector;
in which:
the negative electrode active material has the overall composition:
MₐSi_{b}P_{c}B_{d};
in which:
0<a<1, 0<b<1, 0<c<1, 0<d<1, and a+b+c+d=1; and
M is selected from the group consisting of Ti, Zr, Hf, V, Nb, Ta, Cr, Mo, W, Tc, Cu, Zn, Pd, Ag, Cd, Au, Mn, Co, Ni, Sn, and Re, and mixtures thereof.

2. The negative electrode of claim 1, wherein M is Mo (molybdenum).

3. The negative electrode of claim 1, wherein the negative electrode active material comprises the form MoₐSi_{b}P_{c}B_{d};
in which:
0<a<1, 0<b<1, 0<c<1, 0<d<1, and a+b+c+d=1.

4. The negative electrode of claim 1, wherein the negative electrode active material is Mo_{0.2}—Si_{0.2}—P_{0.4}—B_{0.2}.

5. The negative electrode of claim 1, wherein lithium has been incorporated into the negative electrode active material.

6. A non-aqueous electrolyte secondary battery comprising:
a positive electrode;
a negative electrode;
a non-aqueous electrolyte between the positive electrode and the negative electrode;
in which:
the non-aqueous electrolyte comprises a non-aqueous solvent and a lithium salt;
the positive electrode comprises a positive electrode current collector, and, on the positive electrode current collector, a mixture comprising a positive electrode active material, a first conductive material, and a first binder;
the positive electrode material is a compound capable of occluding and releasing lithium ions;
the negative electrode comprises a negative electrode current collector, and, on the negative electrode current collector, a mixture comprising a negative electrode active material, a second conductive material, and a second binder;
in which:
the negative electrode active material has the overall composition:
MₐSi_{b}P_{c}B_{d};
in which:
0<a<1, 0<b<1, 0<c<1, 0<d<1, and a+b+c+d=1; and
M is selected from the group consisting of Ti, Zr, Hf, V, Nb, Ta, Cr, Mo, W, Tc, Cu, Zn, Pd, Ag, Cd, Au, Mn, Co, Ni, Sn, and Re, and mixtures thereof.

7. The non-aqueous electrolyte secondary battery of claim 6, wherein M is Mo (molybdenum).

8. The non-aqueous electrolyte secondary battery of claim 6, wherein the negative electrode active material comprises the form MoₐSi_{b}P_{c}B_{d};
in which:
0<a<1, 0<b<1, 0<c<1, 0<d<1, and a+b+c+d=1.

9. The non-aqueous electrolyte secondary battery of claim 6, wherein the negative electrode active material is Mo_{0.2}—Si_{0.2}—P_{0.4}—B_{0.2}.

10. The non-aqueous electrolyte secondary battery of claim 6, wherein lithium has been incorporated into the negative electrode active material.

11. A method for preparing a negative electrode of a non-aqueous electrolyte secondary battery, the method comprising the steps of:
preparing a mixture comprising a negative electrode active material, a conductive material, a binder, and a solvent;
coating the mixture on a current collector; and
drying the mixture to produce the negative electrode:
in which:
the negative electrode active material has the overall composition:
MₐSi_{b}P_{c}B_{d};
in which:
0<a<1, 0<b<1, 0<c<1, 0<d<1, and a+b+c+d=1; and
M is selected from the group consisting of Ti, Zr, Hf, V, Nb, Ta, Cr, Mo, W, Tc, Cu, Zn, Pd, Ag, Cd, Au, Mn, Co, Ni, Sn, and Re, and mixtures thereof.

12. The method of claim 11, wherein M is Mo (molybdenum).

13. The method of claim 11, wherein the negative electrode active material comprises the form MoₐSi_{b}P_{c}B_{d};
in which:
0<a<1, 0<b<1, 0<c<1, 0<d<1, and a+b+c+d=1.

14. The method of claim 11, wherein the negative electrode active material is Mo_{0.2}—Si_{0.2}—P_{0.4}—B_{0.2}.

15. The method of claim 11 further comprising the step of incorporating lithium into the negative electrode active material.

16. The negative electrode of claim 1, wherein 0<a≦0.20.

17. The non-aqueous electrolyte secondary battery of claim 7, wherein 0<a≦0.20.

18. The method of claim 11, wherein 0<a≦0.20.
